(19) United States
(12) Patent Application Publication
(10) Pub. No.: US 2009/0303436 A1
(43) Pub. Date: Dec. 10, 2009

(54) Discoloration of sports and military items for vision training

(76) Inventor: Gary Alan Brown, Kelowna (CA)

Correspondence Address: GARY ALAN BROWN, 4005 SANTA ANITA PL., KELOWNA, BC, V1W-2Z6, CA

(21) Appl. No.: 11/893,629

(22) Filed: Aug. 16, 2007

(51) Int. Cl. A61H 5/00

(52) U.S. Cl. 351/203

(57) ABSTRACT

Findings by sports optometrists conclude that sporting hand eye coordination is improved when high color contrast between figure and ground exist. Ground is defined as any and all possible background coloring. Figure herein refers to the prime sports objects; soccer balls, baseballs, footballs, bowling pins, handballs, lawn bowling posts, pucks, ringette rings, horseshoe pins, polo balls, golf balls, ping pong balls, badminton birds, hand balls, volleyballs, racquet balls and any military targets, that can be made available in discolored selections, including but not limited to; green, blue, white, two color combinations such as but not limited to; white and gray, red and white yellow and white. Military targets may be prepared in camouflage, or any colors expected to be replication of critical naturally anticipated backgrounds. Among these are the greens and browns of earth, blue and blue-green of sea, and various blues and cloud conditions of the sky and dark shades of night. High contrast improves visual performance and the accompanying hand eye or hand foot coordination needed in athletics leading to improved sport performance. It hence follows that practicing with discolored contrast, referred herein as specific discoloration of the prime sports object, and military targets, challenges the athlete to elevate visual competence and performance. Training the eyes to handle less agreeable colors by use of the method described improves the visual acuity and associated hand-eye or foot-eye coordination to raise athletic performance in contests and games and military performance in battle.

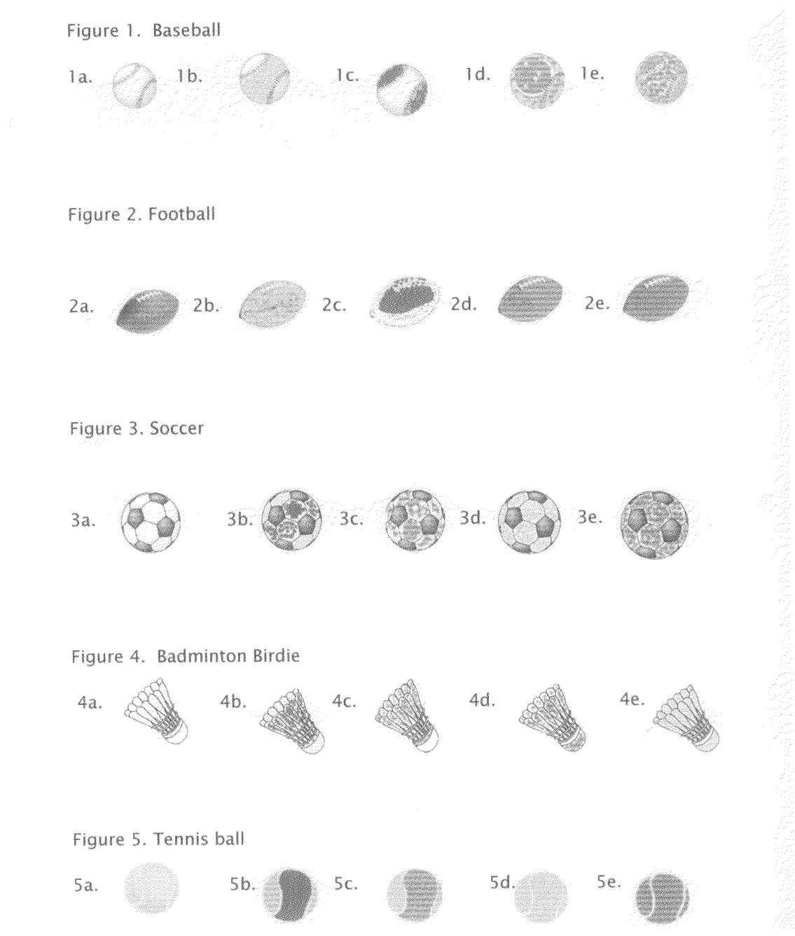

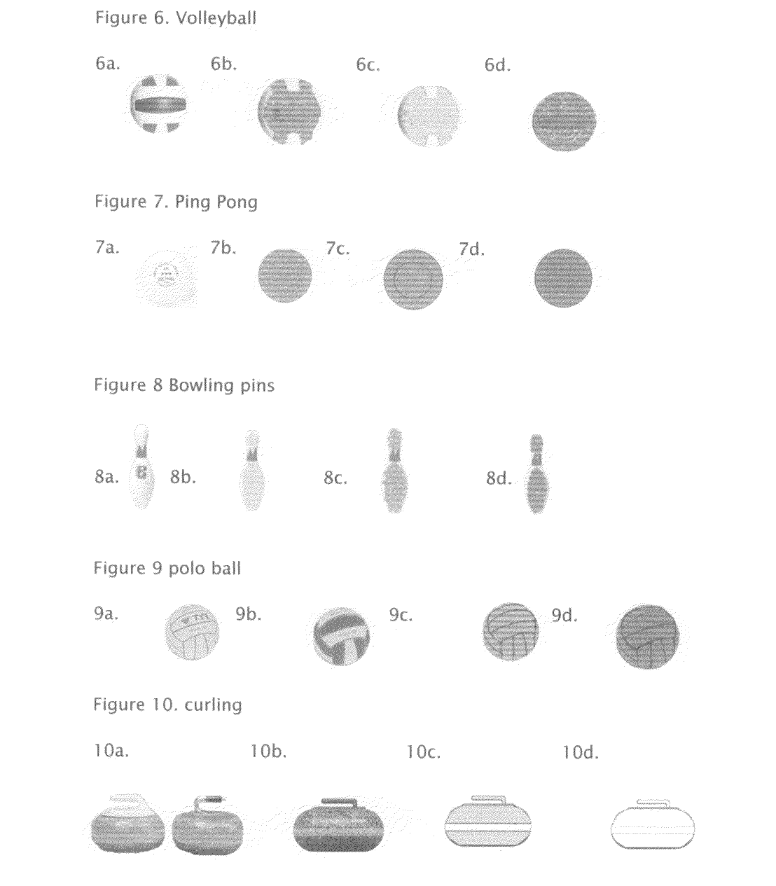

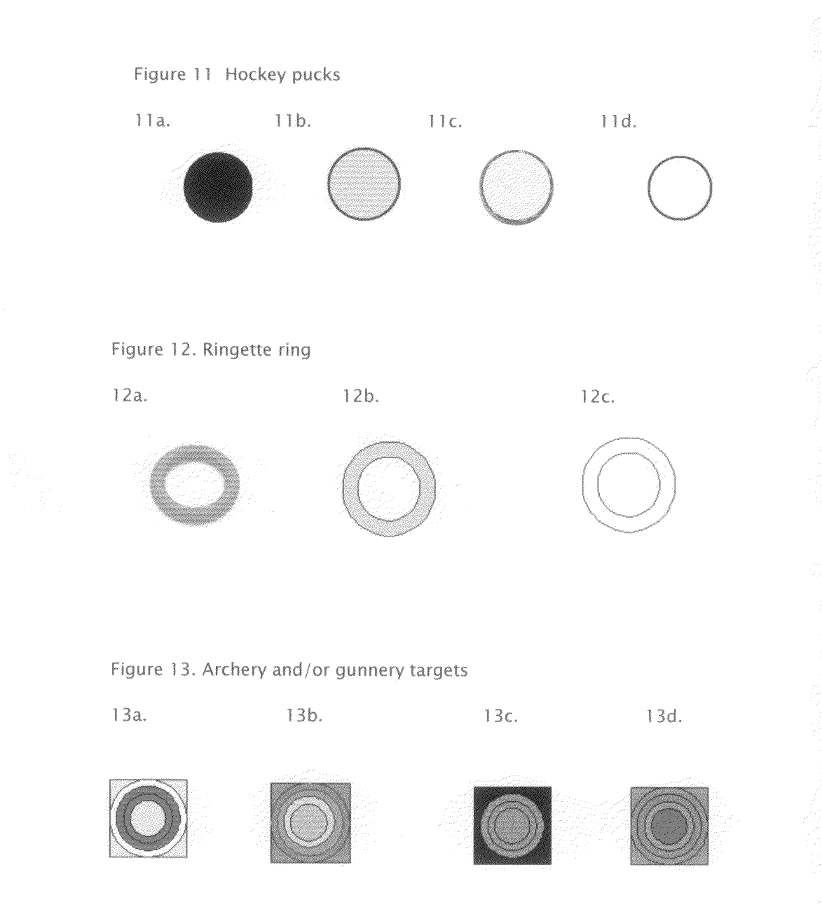

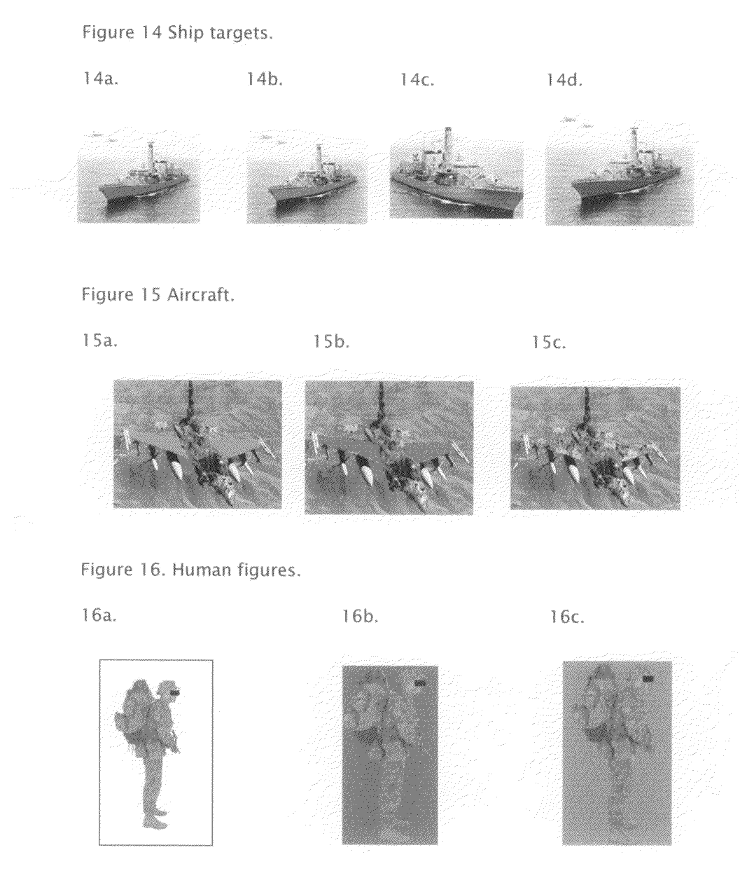

The common sport's principal objects, baseballs, footballs, soccer balls, birdies, Frisbee's, pucks, bowling pins, baskets, nets, boundaries, are traditionally high contrast colors that offer ready visual recognition. Changing said ready recognition, by discoloring, to a less visual object, and/or changing design or texture to conditions of low visibility reduces ready visual definition. Continued practice with prepared discolored substitute articles will elevate the athlete to higher functioning hence delivering better performance.

Similarly in military service targets and objects for practice shooting are similarly contrast colored with respect to the background in use. Discoloration of these targets or objects again to less contrast versions challenges the vision capability and continued practice builds better vision ability and enhanced performance in real situations.

The use of this discoloration, including design or texture or any combinations thereof is known by sports optometrists to reduce the ability to perform. It therefore follows that said method of selected discoloration usage for said sport principal objects training and said military targeting training in practice sessions will improve hand eye coordination and consequent athletic and military effectiveness.

The use of this discoloration in training methods described herein consist of deliberate object change in color or surface pattern design, or both, based upon the findings of sport optometrists to substitute miss-colored items of minimal visual contrast in training sessions. Continued training with this minimal visual contrast method will contribute an elevation of overall hand eye coordination that improves both athletes and military personnel ability to perform on the playing field, court, or battle field. It is further part of the discoloration or surface variation training method to deliberately obfuscate the identity of the principal object [including but not limited to said ball, bird, Frisbee etc.] such that the chosen color or design for training be one that molds into the background, diminishing easy visual identification through sharp visual contrast. Said diminishing of visual identification raises personal effort to accommodate the difficulty and in the end provides an elevated level of performance using the conventional color or surface material preparation.

Hence soccer balls, baseballs, footballs, bowling pins, handballs, lawn bowling posts, pucks, horseshoe pins, polo balls, golf balls, ping pong balls, racquet balls, ringette rings, can be made available in discolored versions, including but not limited to; green, blue, white, two or three color combinations such as, but not limited to; white, black, gray, red, yellow, blue, green and orange.

Discoloration of practice targets suitable to military training calls for backgrounds in; the green and browns of earth, blue and blue-green of sea, various blues and cloud colors of the sky and the varying shades dusk, dawn and of night.

In many cases training specimens of said sport and military targets may be done in multi-colors reflective of natural circumstance colors. In sports gymnasium floor and/or wall coloring is anticipated. In some instances discoloring objects are preferred in multicolored combinations that create suitable disguise by use of a multicolored environmental back-ground. Said back-ground of course creates the low contrast antithesis by preparing sports primary objects and military targets with poor or low contrasting colors, textures and designs.

Reducing the foreground/background contrast by the cited discoloration described herein for the purpose of training deliberately employing reduced visual recognition supports the improved training of enhanced eye performance that links immediately to superior hand eye coordination and hence contributes to improved athletic and military performance. With such deliberately created confusion in visual cues, as the sports optometrists refer to them, produced by said discoloration, the training athlete and military personnel, will respond in persistent training employing said discoloration by elevating his or her visual skills to the requirement demanded by the newly fashioned low background contrasting for primary sports objects and military targets.

With such improved skills in actual games and battle the athlete and military personnel can now perform at a higher level than an equivalent athlete or military person without the benefit of discoloration training and hence also without additional trained skills in visual recognition and response.

### FIGURES AND DIAGRAMS

All figures and diagrams are comparative and move from conventional toward species of discoloration, usually becoming more difficult practice targeting moving from left to right on the page.

Left to right on the page. Xa is the traditional, Xb typically highly colored illustrative of crowds in various loud coloured dress, Xc, is usually a sky with cloud combination, Xd, is a muted background of grass or grass and earth, Xe, the most muted favored discoloring. All beyond Xa, are versions of discoloration, but not limiting in preferred versions in this patent filing. Included herein the left to right range describes the advantage in visual training and consequent superior development hand eye coordination of athletes and military personnel with the use of said discoloration objects.

What is claimed is:

1. The method of training using specifically discolored sports objects such as soccer balls, baseballs, footballs, basketballs tennis balls, bowling pins, handballs, lawn bowling posts, pucks, ringette rings, horseshoe pins, polo balls, golf balls, ping pong balls, badminton birds, hand balls, volleyballs, curling rocks, and racquet balls when made available in hard to see discolored selections, including but not limited to; green, blue, white, two color combinations such as; white and gray, red and white yellow and white. create improved eye competence training and improved hand eye coordination thus improving athletic performance in contests and games. Military targets such as personnel, tanks, gun emplacements, ships, aircraft may similarly when prepared in camouflage, or any hard to see colors create similar improved vision effectiveness and eye-hand gunnery expertise. Among the suitable colors, but not limited thereto are; the green and browns of earth, blue and blue-green of sea, and various blues with cloud patterns of the sky and dark shades of night creates improved eye competence and improves associated hand eye coordination thus improving military performance in battle and combat.

2. As in [1] above when discoloration includes several versions of discoloration, as is indicated in the diagrams to follow, the eye hand coordination improvements may well be superior to simply shifting to the extremely difficult visual recognition version in any of cited sports or military targets.

3. The entire process of discoloration leads to more purposeful variations in training and improved response to ever increasing deepening of low quality visual perception of prepared cited objects. The method of training using specifically discolored said sports prime objects and said military targets can be made available in purposely increasing difficulty of the discolored object colors, including but not limited to; green, blue, white, two color combinations such as; white and gray, red and white yellow and white specifically to reduce the natural visual cue and advantage of contrasting figure and ground. Military targets may similarly be done in loud camouflage, or any graduation of colors expected to be replication of the naturally anticipated backgrounds. Among these, but not limited thereto are; the green and browns of earth, blue and blue-green of sea, and various blues with cloud patterns of the sky, and dark shades of night. This graduation in discoloring tactics pre-trains the user's eye visual acuity in stages and challenges users in training to rise to new and superior level of performance in both visual capability and hand eye coordination.

4. Visual training utilizing the cited objects and the said combinations of hard to see discoloring of figures may be both continued and repeated as required to assure and maintain a superior level of capability in hand eye coordination as well as allowing ‘top up’ training sessions to fine tune performance in visual acuity and associated elevated hand eye performance. The method of training using specifically discolored sports prime objects and targets in training; such as soccer balls, baseballs, footballs, basketballs, tennis balls, bowling pins, handballs, lawn bowling posts, pucks, ringette rings, horseshoe pins, polo balls, golf balls, ping pong balls, badminton birds, hand balls, volleyballs, curling rocks, and racquet balls and any given military targets, can be made available for top-up and remedial training sessions in discolored selections, that create superior hand eye coordination upon application of suitable training times and variations in combination of hard to see combinations of discoloration of figure and ground.

5. As in [4] above graduations of training discoloration may be added for use in top-up and remedial training with equally effective results. Such top-up training may be computerized and used with daily or weekly training by timing the computer mouse click in response to flashing visible patterns demonstrating discoloration and containing experiences with graduations of more and more deep discolorations until the target becomes almost invisible.
